(19) United States
(12) Patent Application Publication
(10) Pub. No.: US 2026/0339130 A1
(43) Pub. Date: Oct. 29, 2026

(54) MODULATORS INCLUDING MULTIPLE RING RESONATORS

(71) Applicant: GlobalFoundries U.S. Inc., Malta, NY (US)

(72) Inventor: Yusheng Bian, Ballston Lake, NY (US)

(21) Appl. No.: 19/187,191

(22) Filed: Apr. 23, 2025

(51) Int. Cl. G02F 1/015; G02B 6/293; G02F 1/025

(52) U.S. Cl. CPC G02F 1/0154; G02B 6/29343; G02F 1/025; G02F 2202/06; G02F 2202/103; G02F 2202/104; G02F 2202/105; G02F 2203/15

(57) ABSTRACT

Structures for a modulator and methods of forming such structures. The structure comprises a bus waveguide core, a first micro-ring resonator including a first ring waveguide core, and a second micro-ring resonator including a second ring waveguide core. The first ring waveguide core includes a first undoped portion adjacent to a portion of the bus waveguide core and a second undoped portion. The second ring waveguide core includes a doped portion and an undoped portion adjacent to the second undoped portion of the first ring waveguide core.

### BACKGROUND

This disclosure relates to photonic chips and, more specifically, to structures for a modulator and methods of forming such structures.

Photonic chips are used in many applications and systems including, but not limited to, data communication systems and data computation systems. A photonic chip includes a photonic integrated circuit comprised of photonic components, such as modulators, polarizers, and couplers, that are used to manipulate light received from a light source, such as an optical fiber or a laser.

Micro-ring modulators are photonic components that may be used to construct optical links. For example, micro-ring modulators may be utilized for high-speed, low-power on-chip and chip-to-chip optical links in data centers and high-performance computing. A micro-ring modulator includes a ring-shaped waveguide core. Light is typically coupled from a bus waveguide core to the ring-shaped waveguide core of the micro-ring modulator. The light resonantly increases in intensity at specific wavelengths for which the circumference of the ring-shaped waveguide core is equal to an integer multiple of the wavelength of the light. The resonant wavelength can be shifted by modulating the refractive index of the material constituting the ring-shaped waveguide core. The intensity of transmitted light in the bus waveguide core changes as the resonant wavelength is shifted by the refractive index modulation.

A micro-ring modulator has a compact footprint compared to other types of modulators, such as a Mach-Zehnder modulator. However, a micro-ring modulator suffers from limitations, such as a restricted extinction ratio for high-speed operation, that restrict implementation in a photonic integrated circuit.

Improved structures for a modulator and methods of forming such structures are needed.

### SUMMARY

In an embodiment of the invention, a structure for a modulator is provided. The structure comprises a bus waveguide core, a first micro-ring resonator including a first ring waveguide core, and a second micro-ring resonator including a second ring waveguide core. The first ring waveguide core includes a first undoped portion adjacent to a portion of the bus waveguide core and a second undoped portion. The second ring waveguide core includes a doped portion and an undoped portion adjacent to the second undoped portion of the first ring waveguide core.

In an embodiment of the invention, a method of forming a structure for a modulator is provided. The method comprises forming a bus waveguide core, forming a first micro-ring resonator including a first ring waveguide core, and forming a second micro-ring resonator including a second ring waveguide core. The first ring waveguide core includes a first undoped portion adjacent to a portion of the bus waveguide core. The second ring waveguide core includes a doped portion and an undoped portion adjacent to a second undoped portion of the first ring waveguide core.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 is a top view of a structure at an initial fabrication stage of a processing method in accordance with embodiments of the invention.

FIG. 2 is a cross-sectional view taken generally along line 2-2 in FIG. 1.

FIG. 2A is a cross-sectional view taken generally along line 2A-2A in FIG. 1.

FIGS. 3, 3A are cross-sectional views of the structure at a fabrication stage of the processing method subsequent to FIGS. 1, 2, 2A.

FIG. 4 is a top view of a structure in accordance with alternative embodiments of the invention.

FIG. 5 is a top view of a structure in accordance with alternative embodiments of the invention.

FIG. 5A is a cross-sectional view taken generally along line 5A-5A in FIG. 5.

FIG. 6 is a top view of a structure in accordance with alternative embodiments of the invention.

### DETAILED DESCRIPTION

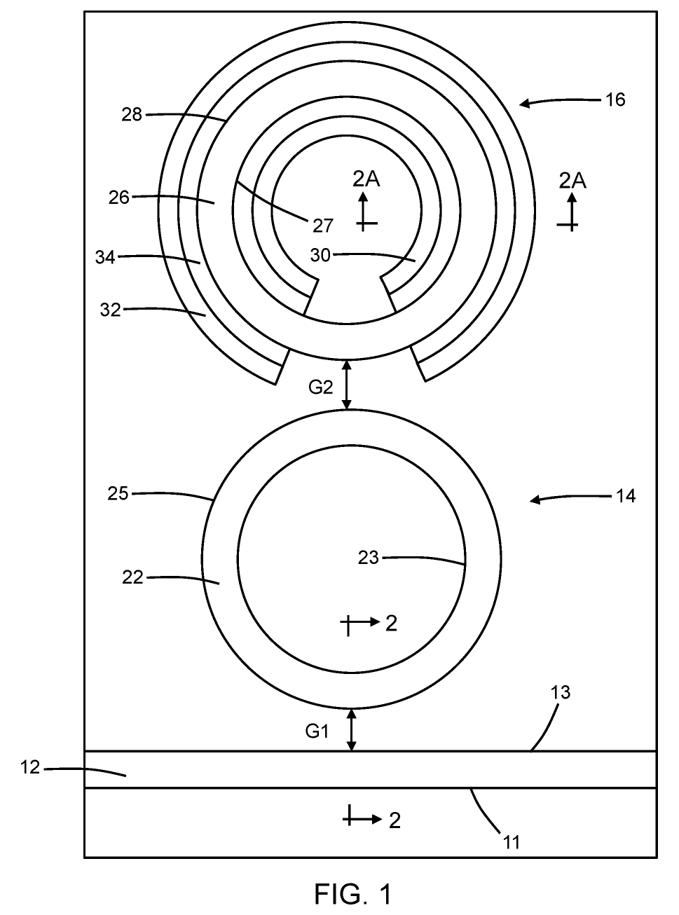

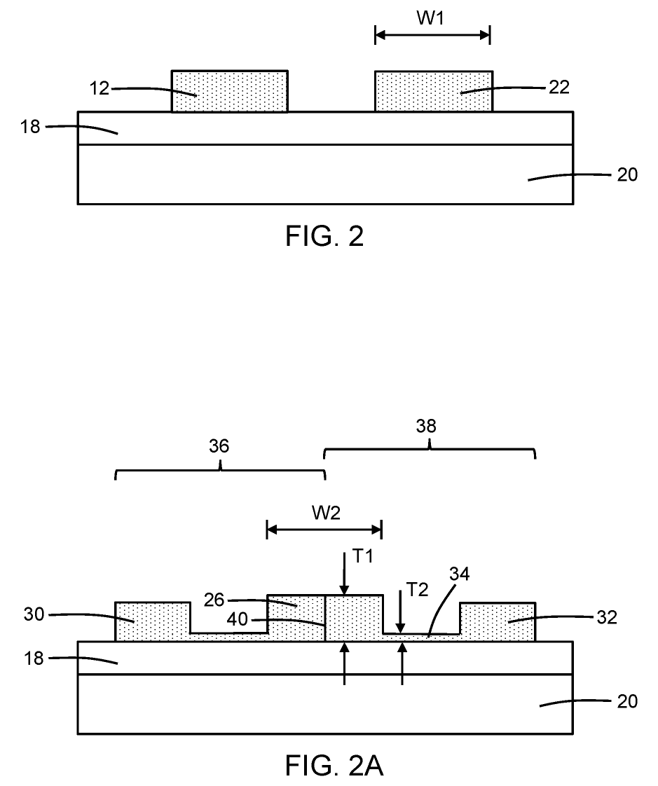

With reference to FIGS. 1, 2, 2A and in accordance with embodiments of the invention, a structure 10 for a modulator includes a bus waveguide core 12, a micro-ring resonator 14, and a micro-ring resonator 16 that is cascaded with the micro-ring resonator 14. The bus waveguide core 12 and the micro-ring resonators 14, 16 are positioned on, and overlie, a dielectric layer 18 and a semiconductor substrate 20. In an embodiment, the dielectric layer 18 may be comprised of a dielectric material, such as an oxide (e.g., silicon dioxide), and the semiconductor substrate 20 may be comprised of a semiconductor material, such as single-crystal silicon. In an embodiment, the dielectric layer 18 may be a buried oxide layer of a silicon-on-insulator substrate. The dielectric layer 18 may provide low-index cladding that optically isolates the bus waveguide core 12 and the micro-ring resonators 14, 16 from the semiconductor substrate 20.

The micro-ring resonator 14 is laterally arranged between the micro-ring resonator 16 and a portion of the bus waveguide core 12. The micro-ring resonator 14 includes a ring waveguide core 22 having a closed shape. In an embodiment, the ring waveguide core 22 may have an inner sidewall 23 and an outer sidewall 25 opposite from the inner sidewall 23. In an embodiment, the micro-ring resonator 14 may represent a passive photonic component in that the micro-ring resonator 14 lacks a mechanism, such as a biased p-n junction or a heater, for changing the refractive index of the material of the ring waveguide core 22 either electro-optically or thermo-optically. In an embodiment, the ring waveguide core 22 has a width dimension W1 between an inner boundary coextensive with the inner sidewall 23 and an outer boundary coextensive with the outer sidewall 25 that may be constant about its perimeter. In an embodiment, the inner sidewall 23 may be circular or round and the outer sidewall 25 may also be circular or round to define an annular shape. In an alternative embodiment, the ring waveguide core 22 may have a non-round shape, such as a racetrack or oblong shape with the inner sidewall 23 and the outer sidewall 25 having straight sections in light-coupling regions and curved end sections that join the straight sections. In an alternative embodiment, a partially-etched slab layer may be connected to a lower portion of the ring waveguide core 22.

The micro-ring resonator 16 includes a ring waveguide core 26 having a closed shape. In an embodiment, the ring waveguide core 26 may have an inner sidewall 27 and an outer sidewall 28 opposite from the inner sidewall 27. The micro-ring resonator 16 includes a ridge 30, a ridge 32, and a slab layer 34 that couples a portion of the ring waveguide core 26 to the ridges 30, 32. The portion of the ring waveguide core 26 is positioned in a lateral direction between the ridge 30 and the ridge 32, the slab layer 34 includes a portion that connects the ridge 30 to the inner sidewall 27 of the ring waveguide core 26, and the slab layer 34 includes a portion that connects the ridge 32 to the outer sidewall 28 of the ring waveguide core 26.

The ring waveguide core 26 has a thickness T1, relative to the horizontal plane of the dielectric layer 18, and the slab layer 34 has a thickness T2, also relative to the horizontal plane of the dielectric layer 18, that is less than the thickness T1. The ring waveguide core 26 has a width dimension W2 between an inner boundary coextensive with the inner sidewall 27 and an outer boundary coextensive with the outer sidewall 28 that may be constant about its perimeter. In an embodiment, the inner sidewall 27 may be circular or round and the outer sidewall 28 may also be circular or round to define an annular shape. In an alternative embodiment, the ring waveguide core 26 may have a non-round shape, such as a racetrack or oblong shape with the inner sidewall 27 and the outer sidewall 28 having straight sections in light-coupling regions and curved end sections that join the straight sections.

In an embodiment, the width dimension W2 of the ring waveguide core 26 may be equal to the width dimension W1 of the ring waveguide core 22. In an embodiment, the ring waveguide core 26 may have the same dimensions as the ring waveguide core 22. In an embodiment, the ring waveguide core 26 may have different dimensions in the horizontal plane than the ring waveguide core 22.

A doped region 36 may be formed in the ridge 30, a doped portion of the ring waveguide core 26, and a portion of the slab layer 34 between the ridge 30 and the doped portion of the ring waveguide core 26. In an embodiment, the doped region 36 may contain a concentration of an n-type dopant, such as phosphorus, to provide n-type conductivity. The doped region 36 may be formed by implanting ions, such as ions including the n-type dopant, with an implantation mask having an opening defining the intended location for the doped region 36. The implantation conditions, such as ion species, dose, and kinetic energy, may be selected to tune the electrical and physical characteristics of the doped region 36.

A doped region 38 may be formed in may be formed in the ridge 32, the doped portion of the ring waveguide core 26, and a portion of the slab layer 34 between the ridge 32 and the doped portion of the ring waveguide core 26. In an embodiment, the doped region 38 may contain a concentration of a p-type dopant, such as boron, to provide p-type conductivity. The doped region 38 may be formed by implanting ions, such as ions including the p-type dopant, with an implantation mask having an opening defining the intended location for the doped region 38. The implantation conditions, such as ion species, dose, and kinetic energy, may be selected to tune the electrical and physical characteristics of the doped region 38.

The doped region 36 has an opposite conductivity type from the doped region 38. The doped region 36 may adjoin the doped region 38 to form a p-n junction 40 inside the portion of the ring waveguide core 26 that is connected to the ridges 30, 32 by the slab layer 34. The micro-ring resonator 16 is an active photonic component in that the micro-ring resonator 16 has a mechanism, namely biasing the p-n junction 40, that permits the refractive index of the material of the ring waveguide core 26 to be modulated in order to change the resonance wavelength. In embodiments, the p-n junction 40 may be produced by different dopant profiles, such as a vertical profile, a lateral profile, an S-type profile, a Z-type profile, or an interdigitated profile. In an alternative embodiment, the conductivity types of the doped region 36 and the doped region 38 may be swapped.

The ridges 30, 32 may have non-closed and open shapes in which the ridges 30, 32 are absent adjacent to the ring waveguide core 22 of the micro-ring resonator 14. As a result, only a portion of the ring waveguide core 26 is coupled by the slab layer 34 to the ridges 30, 32. The doped regions 36, 38, which extend into the ring waveguide core 26 and the ridges 30, 32, and the p-n junction 40 only extend about the doped portion of the ring waveguide core 26. The doped regions 36, 38 and the p-n junction 40 are absent in the undoped portion of the ring waveguide core 26 that is adjacent to the ring waveguide core 22. The p-n junction 40 may end at a transition from the doped portion of the ring waveguide core 26 to the undoped portion of the ring waveguide core 26, and the undoped portion of the ring waveguide core 26 may provide a discontinuity in the doped portion of the ring waveguide core 26.

The portion of the micro-ring resonator 16 including doped regions 36, 38 in the ridges 30, 32, the slab layer 34, and the doped portion of the ring waveguide core 26 coupled by the slab layer 34 to the ridges 30, 32 constitute an electro-optic modulator. A portion of the ring waveguide core 22, which is undoped, is spaced from a portion of the bus waveguide core 12, which is undoped, by a gap G1 across which light can be coupled in a light-coupling region. A portion of the ring waveguide core 26, which is undoped, is spaced from a portion of the ring waveguide core 22, which is undoped, by a gap G2 across which light can be coupled in a light-coupling region. In an embodiment, the gap G2 may be equal to the gap G1. The undoped portions of the ring waveguide core 22 are spaced about the perimeter of the ring waveguide core 22 to coincide with the light-coupling regions.

The doped portion of the ring waveguide core 26 incorporates the doped regions 36, 38 and the p-n junction 40. The continuity of the doped portion of the ring waveguide core 26 is interrupted by the undoped portion in the light-coupling region shared with the undoped portion of ring waveguide core 22.

In an embodiment, the bus waveguide core 12 and the micro-ring resonators 14, 16 may be comprised of a material having a refractive index that is greater than the refractive index of silicon dioxide. In an embodiment, the bus waveguide core 12 and the micro-ring resonators 14, 16 may be comprised of a semiconductor material, such as single-crystal silicon, amorphous silicon, or polysilicon. In alternative embodiments, other materials, such as a III-V compound semiconductor, lithium niobate, or barium titanate, may be used to form the bus waveguide core 12 and the micro-ring resonators 14, 16.

In an embodiment, the bus waveguide core 12 and the micro-ring resonators 14, 16 may be formed by patterning a layer comprised of its constituent material with lithography and etching processes. In an embodiment, an etch mask may be formed by a lithography process over the layer, and unmasked sections of the layer may be etched and removed with an etching process. In an embodiment, the bus waveguide core 12 and the micro-ring resonators 14, 16 may be formed by patterning the single-crystal silicon of the device layer of a silicon-on-insulator substrate. In an embodiment, the bus waveguide core 12 and the micro-ring resonators 14, 16 may be formed by patterning a deposited layer comprised of their constituent material. The slab layer 34 may be formed by partially etching through portions of the layer of material that is patterned to form the ring waveguide core 26 and the ridges 30, 32.

In an embodiment, the modulator embodied in the structure 10 may be deployed in a multi-channel transmitter. In an embodiment, the modulator embodied in the structure 10 may be deployed in the transmitter and receiver of a multi-channel transceiver. In an embodiment, the bus waveguide core 12 may constitute an arm of a ring-assisted Mach-Zehnder interferometer. The modulator embodied in the structure 10 may include additional ring resonators like the micro-ring resonator 14 and/or the micro-ring resonator 16 that are cascaded with the micro-ring resonators 14, 16 to construct a higher order modulator.

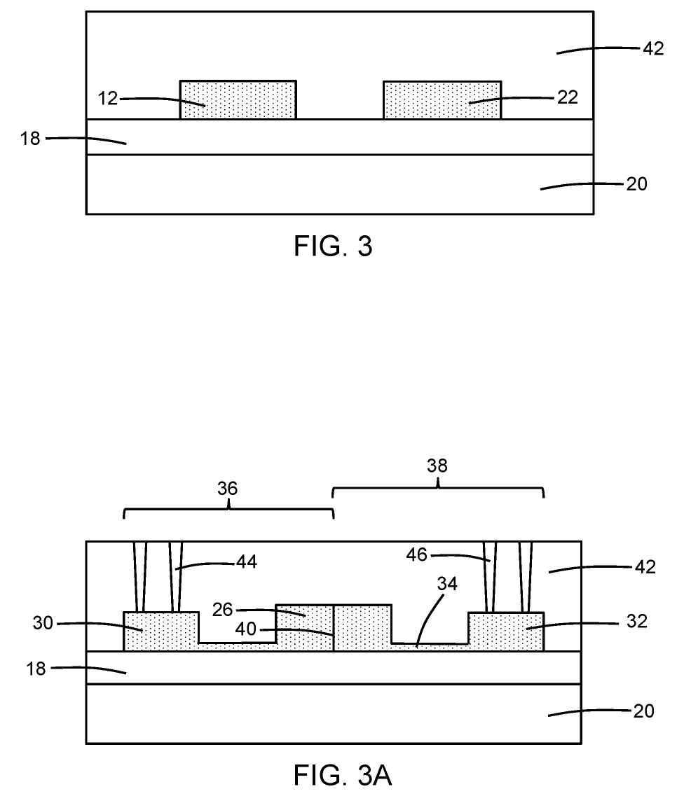

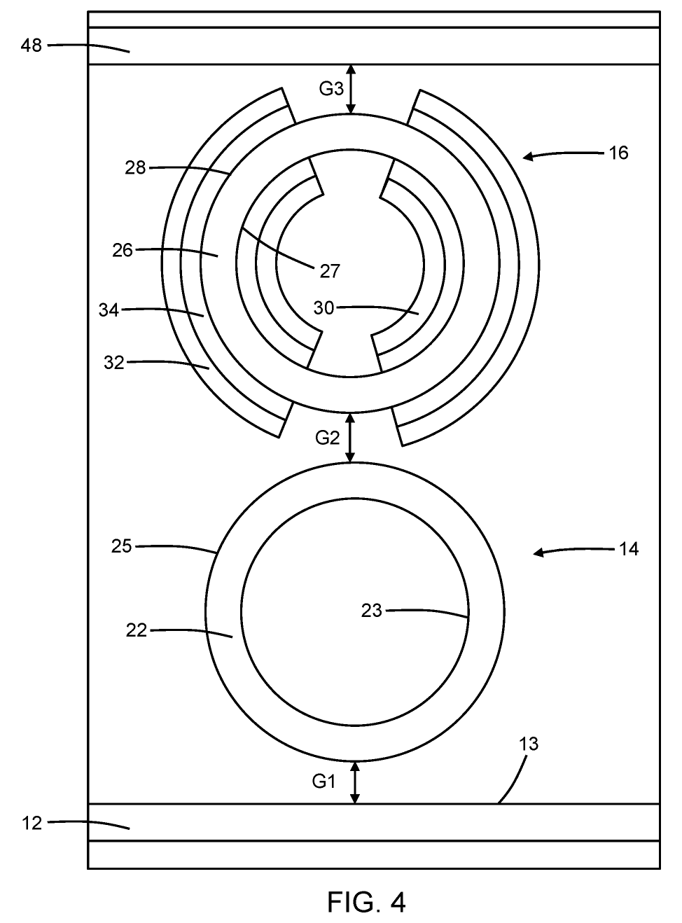

With reference to FIGS. 3, 3A in which like reference numerals refer to like features in FIGS. 1, 2, 2A and at a subsequent fabrication stage, a dielectric layer 42 may be formed that overlies the bus waveguide core 12 and the micro-ring resonators 14, 16. The dielectric layer 42 may be comprised of a dielectric material, such as silicon oxide (e.g., silicon dioxide).

Contacts 44 may be formed in the dielectric layer 42 that are coupled to the ridge 30 that includes a portion of doped region 36, and contacts 46 may be formed in the dielectric layer 42 that are coupled to the ridge 32 that includes a portion of the doped region 38. The contacts 44, 46 may be comprised of a metal, such as tungsten. The contacts 44, 46 may be used to supply a voltage to the electro-optic modulator that biases the p-n junction 40 inside the ring waveguide core 26. The bias voltage may be utilized to shift the resonant wavelength of the micro-ring resonator 16 by modulating the refractive index of the material of the ring waveguide core 26, which changes the intensity of transmitted light in the bus waveguide core 12.

The electro-optic modulator embodied in the structure 10 may provide efficient modulation enabling a significant improvement in the extinction ratio, especially for high-speed operation. The improvement in extinction ratio may be achieved without sacrifices to other performance metrics, such as bandwidth and/or insertion loss. In embodiments, the portion of the ring waveguide core 22 and the portion of the ring waveguide core 26 involved in the light-coupling regions may have a varying width dimension and/or a varying curvature to improve the light transfer and/or to enhance the fabrication tolerance of the electro-optic modulator embodied in the structure 10.

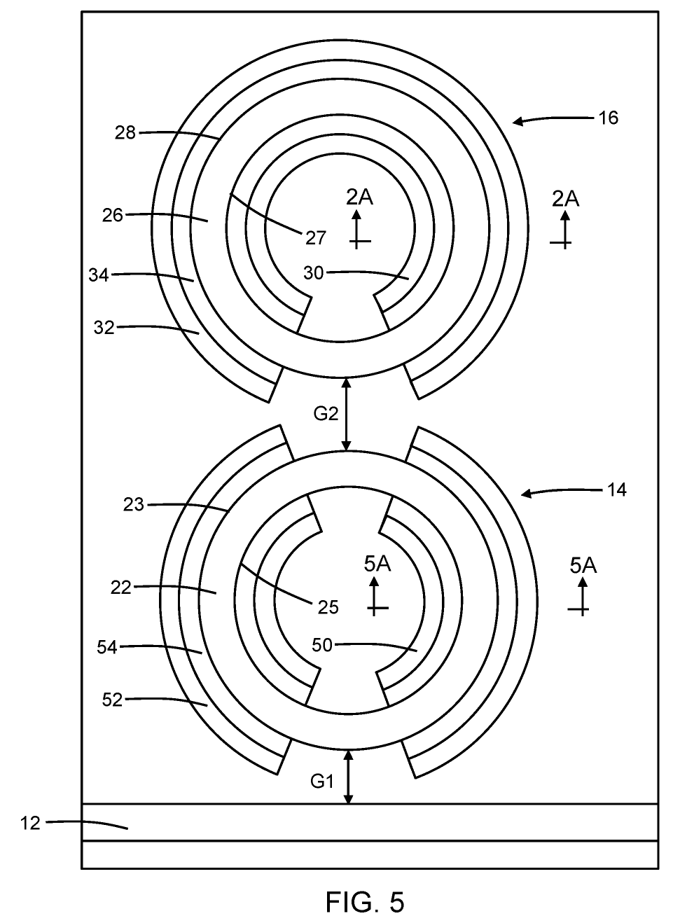

With reference to FIG. 4 and in accordance with alternative embodiments, the ridge 30, the ridge 32, the slab layer 34, the doped regions 36, 38, and the p-n junction 40 may be divided and split into sections that constitute individual and separate electro-optic phase shifters of the micro-ring resonator 16. In that regard, the ridges 30, 32, the slab layer 34, the doped regions 36, 38, and the p-n junction 40 may include multiple discontinuities in respective light-coupling regions that add an additional undoped portion to the ring waveguide core 26. In an embodiment, the additional undoped portion of the ring waveguide core 26 may be arranged in a light-coupling region adjacent to a portion of a bus waveguide core 48, which may function as a drop port and which may be comprised of undoped semiconductor material. The undoped portions of the ring waveguide core 26 are arranged between the doped portions of the ring waveguide core 26. Light may be coupled from the undoped portion of the ring waveguide core 26 across a gap G3 to the adjacent undoped portion of the bus waveguide core 48. The discontinuities in the doped regions 36, 38 and the p-n junction 40, and the locations of the undoped portions of the ring waveguide core 26, coincide with the locations of the gap G2 and the gap G3.

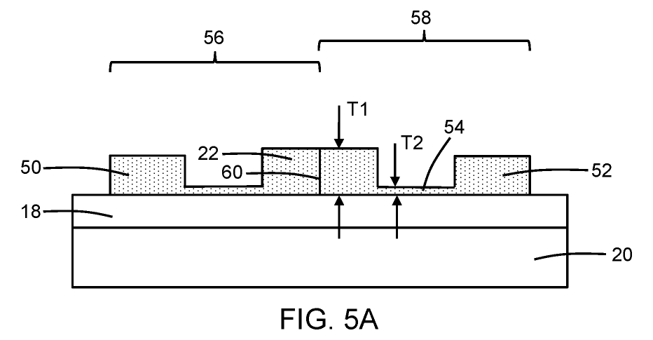

With reference to FIGS. 5, 5A and in accordance with alternative embodiments, the micro-ring resonator 14 may include a ridge 50, a ridge 52, and a slab layer 54 that connects the ridges 50, 52 to the ring waveguide core 22. The ridges 50, 52 and the slab layer 54 are similar, or identical, to the ridges 30, 32 and the slab layer 34. The slab layer 54 includes a portion that connects the ridge 50 to the inner sidewall 23 of the ring waveguide core 26, and the slab layer 54 includes a portion that connects the ridge 52 to the outer sidewall 25 of the ring waveguide core 26. The ring waveguide core 22 may have the thickness T1, and the slab layer 54 may have the thickness T2 that is less than the thickness T1.

A doped region 56 may be formed in doped portions of the ridge 50, doped portions of the ring waveguide core 22, and doped portions of the slab layer 54 between the doped portions of the ridge 50 and the doped portions of the ring waveguide core 26. A doped region 58 may be formed in doped portions of the ridge 50, doped portions of the ring waveguide core 26, and doped portions of the slab layer 54 between the doped portions of the ridge 50 and the doped portions of the ring waveguide core 26. The doped region 56 may adjoin the doped region 58 to form a p-n junction 60 inside the doped portion of the ring waveguide core 22 that is connected to the ridges 50, 52 by the slab layer 54. The doped regions 56, 58 are similar or identical to the doped regions 36, 38 of the micro-ring resonator 16, and the p-n junction 60 is similar or identical to the p-n junction 40 of the micro-ring resonator 16.

The ridge 50, the ridge 52, the slab layer 54, the doped regions 56, 58, and the p-n junction 60 of the micro-ring resonator 14 may be divided and split into sections that constitute individual and separate electro-optic phase shifters of the micro-ring resonator 16. One undoped portion of the ring waveguide core 22, which is not coupled to the ridges 50, 52 by the slab layer 54 and which lacks the doped regions 56, 58 and the p-n junction 60, is arranged in the light-coupling region adjacent to the undoped portion of the bus waveguide core 12. Another undoped portion of the ring waveguide core 22, which is not coupled to the ridges 50, 52 by the slab layer 34 and which lacks the doped regions 56, 58 and the p-n junction 60, is arranged in the light-coupling region adjacent to the undoped portion of the ring waveguide core 26. The undoped portions of the ring waveguide core 22 are arranged between the doped portions of the ring waveguide core 22.

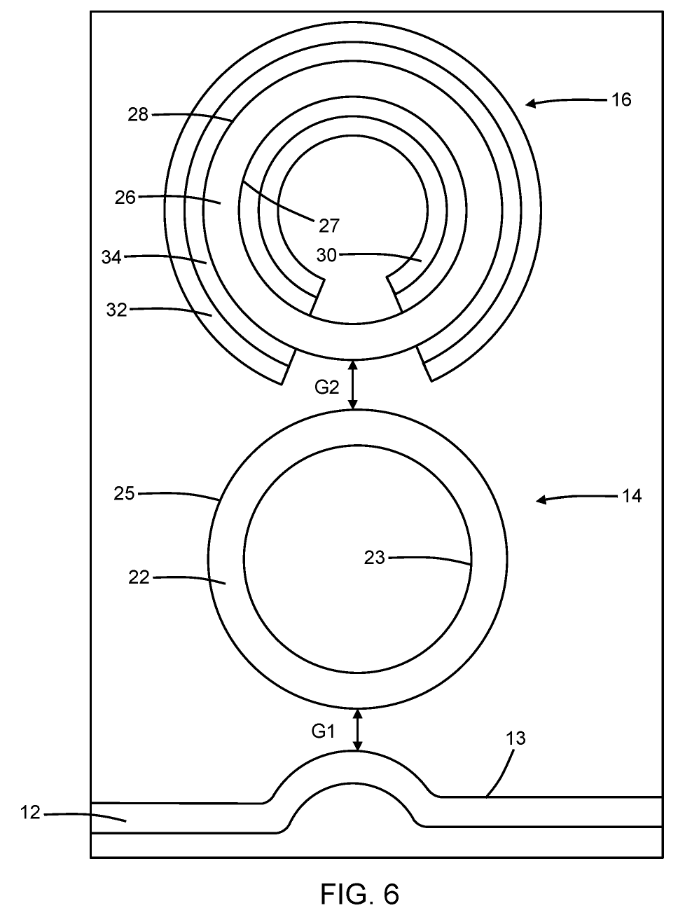

With reference to FIG. 6 and in accordance with alternative embodiments, the portion of the bus waveguide core 12 arranged adjacent to the undoped portion of the ring waveguide core 22 in the light-coupling region may be curved. The curvature of this portion of the bus waveguide core 12 may operate to increase the coupling power for light transfer between the bus waveguide core 12 and the ring waveguide core 22.

The methods as described above are used in the fabrication of integrated circuit chips. The resulting integrated circuit chips can be distributed by the fabricator in raw wafer form (e.g., as a single wafer that has multiple unpackaged chips), as a bare die, or in a packaged form. The chip may be integrated with other chips, discrete circuit elements, and/or other signal processing devices as part of either an intermediate product or an end product. The end product can be any product that includes integrated circuit chips, such as computer products having a central processor or smartphones.

References herein to terms modified by language of approximation, such as “about”, “approximately”, and “substantially”, are not to be limited to the precise value or precise condition as specified. In embodiments, language of approximation may indicate a range of +/- 10% of the stated value(s) or the stated condition(s).

References herein to terms such as “vertical”, “horizontal”, etc. are made by way of example, and not by way of limitation, to establish a frame of reference. The term “horizontal” as used herein is defined as a direction or a plane parallel to a conventional plane of a semiconductor substrate, regardless of its actual three-dimensional spatial orientation. The terms “vertical” and “normal” refer to a direction or plane in the frame of reference perpendicular to the horizontal plane, as just defined. The term “lateral” refers to a direction in the frame of reference within the horizontal plane.

A feature “connected” or “coupled” to or with another feature may be directly connected or coupled to or with the other feature or, instead, one or more intervening features may be present. A feature may be “directly connected” or “directly coupled” to or with another feature if intervening features are absent. A feature may be “indirectly connected” or “indirectly coupled” to or with another feature if at least one intervening feature is present. A feature “on” or “contacting” another feature may be directly on or in direct contact with the other feature or, instead, one or more intervening features may be present. A feature may be “directly on” or in “direct contact” with another feature if intervening features are absent. A feature may be “indirectly on” or in “indirect contact” with another feature if at least one intervening feature is present. A feature may “overlie” another feature if the feature is positioned in elevation over another feature. Different features may “overlap” if a feature extends over, and covers all or a part of, another feature. A feature may “underlie” another feature if the feature is positioned in elevation below another feature.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A structure for a modulator, the structure comprising:
a first bus waveguide core including a portion;
a first micro-ring resonator including a first ring waveguide core, the first ring waveguide core including a first undoped portion adjacent to the portion of the first bus waveguide core and a second undoped portion; and
a second micro-ring resonator including a second ring waveguide core, the second ring waveguide core including a first doped portion and a first undoped portion adjacent to the second undoped portion of the first ring waveguide core.

2. The structure of claim 1 wherein the first doped portion of the second ring waveguide core includes a p-n junction.

3. The structure of claim 2 wherein the first doped portion of the second ring waveguide core adjoins the first undoped portion of the second ring waveguide core, and the p-n junction ends at a transition from the first doped portion of the second ring waveguide core to the first undoped portion of the second ring waveguide core.

4. The structure of claim 1 further comprising:
an electro-optical phase shifter including a slab layer, a first ridge, and a second ridge, the slab layer including a first portion and a second portion, the first ridge connected to the first doped portion of the second ring waveguide core by the first portion of the slab layer, and the second ridge connected to the first doped portion of the second ring waveguide core by the second portion of the slab layer.

5. The structure of claim 4 further comprising:
a first doped region in the first ridge, the first portion of the slab layer, and the first doped portion of the second micro-ring resonator; and
a second doped region in the second ridge, the second portion of the slab layer, and the first doped portion of the second micro-ring resonator,
wherein the first doped region and the second doped region have opposite conductivity types.

6. The structure of claim 5 wherein the first doped region adjoins the second doped region along a p-n junction inside the second ring waveguide core.

7. The structure of claim 1 wherein the second ring waveguide core includes a second doped portion, and the first undoped portion is arranged within the second ring waveguide core between the first doped portion and the second doped portion.

8. The structure of claim 7 wherein the second ring waveguide core includes a second undoped portion, and the first doped portion is arranged within the second ring waveguide core between the first undoped portion and the second undoped portion.

9. The structure of claim 8 further comprising:
a second bus waveguide core,
wherein the second undoped portion of the second ring waveguide core is positioned adjacent to a portion of the second bus waveguide core.

10. The structure of claim 9 wherein the first micro-ring resonator and the second micro-ring resonator are laterally arranged between the first bus waveguide core and the second bus waveguide core.

11. The structure of claim 1 wherein the first micro-ring resonator is laterally arranged between the first bus waveguide core and the second micro-ring resonator.

12. The structure of claim 1 wherein the first undoped portion of the first ring waveguide core and the second undoped portion of the first ring waveguide core are joined by undoped portions of the first ring waveguide core.

13. The structure of claim 1 wherein the first ring waveguide core includes a first doped portion between the first undoped portion and the second undoped portion.

14. The structure of claim 13 wherein the first doped portion of the first ring waveguide core includes a first p-n junction.

15. The structure of claim 14 wherein the first doped portion of the second ring waveguide core includes a second p-n junction.

16. The structure of claim 13 wherein the first ring waveguide core includes a second doped portion, and the first undoped portion is arranged between the second doped portion and the second undoped portion.

17. The structure of claim 1 wherein the portion of the first bus waveguide core is curved.

18. The structure of claim 1 wherein the first ring waveguide core and the second ring waveguide core comprise silicon.

19. The structure of claim 1 wherein the first undoped portion of the first ring waveguide core is spaced from the portion of the first bus waveguide core by a first gap in a first light-coupling region, and the second undoped portion of the first ring waveguide core is spaced from the first undoped portion of the second ring waveguide core by a second gap in a second light-coupling region.

20. A method of forming a structure for a modulator, the method comprising:
forming a bus waveguide core;
forming a first micro-ring resonator including a first ring waveguide core, wherein the first ring waveguide core includes a first undoped portion adjacent to a portion of the bus waveguide core and a second undoped portion; and
forming a second micro-ring resonator including a second ring waveguide core, wherein the second ring waveguide core includes a doped portion and an undoped portion adjacent to the second undoped portion of the first ring waveguide core.
